(19) United States
(12) Patent Application Publication
(10) Pub. No.: US 2014/0042107 A1
(43) Pub. Date: Feb. 13, 2014

(54) Nozzled Confined Container for Treating Sludge

(71) Applicant: John E. Powell, Bakersfield, CA (US)

(72) Inventor: John E. Powell, Bakersfield, CA (US)

(21) Appl. No.: 13/961,632

(22) Filed: Aug. 7, 2013

Related U.S. Application Data
(60) Provisional application No. 61/680,531, filed on Aug. 7, 2012.

(51) Int. Cl. C02F 11/00

(52) U.S. Cl. CPC C02F 11/00
USPC 210/767; 210/512.1

(57) ABSTRACT

The disclosure relates to an apparatus, system, and methodology for treating nested waste matter, including a delivery system for delivering a volume of untreated material; a confined container having an inlet connected to the delivery system; an energy impingement device introduced transversely into said confined container, where the energy impingement device is configured to deliver a volume of injected fluid and further configured to treat the volume of untreated material in said confined container and wherein the confined container has an outlet for exiting a volume of treated material.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

Sludge forms when naturally occurring solids as well as rust and scale from piping and tank walls, and higher molecular weight hydrocarbons separate from lighter hydrocarbons and sink to bottoms. This matter, referred to as sludge, over time forms on the bottom on storage vessels. Operators must deal with this sludge problem as it hampers normal procedures and increases handling and treatment costs.

### BRIEF SUMMARY OF THE EMBODIMENT(S)

An apparatus, system, and methodology for treating nested waste matter, including a delivery system for delivering a volume of untreated material; a confined container having an inlet connected to the delivery system; an energy impingement device introduced transversely into said confined container, where the energy impingement device is configured to deliver a volume of injected fluid and further configured to treat the volume of untreated material in said confined container and wherein the confined container has an outlet for exiting a volume of treated material.

As used herein, the term “transversely” shall refer to any angle not parallel to the direction of flow of untreated material at the inlet to the confined container or angle as shown in the figures.

### BRIEF DESCRIPTION OF THE SEVERAL VIEWS OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a schematic diagram of a portion of a process system having a confined container for effecting one or more process materials.

FIG. 2 depicts a schematic view of the portion of the process system of FIG. 1.

FIG. 3 depicts a view of an end product produced by the process system of FIGS. 1 and 2 side-by-side with an end product resulting from the prior art technology.

### DETAILED DESCRIPTION OF THE EMBODIMENT(S)

The description that follows includes exemplary apparatus, methods, techniques, and instruction sequences that embody techniques of the inventive subject matter. However, it is understood that the described embodiments may be practiced without these specific details.

FIG. 1 depicts a portion of a process system 100 for delivering materials 102 to a location 104. The process system 100 may have a confined container 106 for effecting and/or treating the materials 102 flowing through the process system 100. The process system 100 may be any suitable process system for delivering materials including, but not limited to, a storage tank, a coker unit, a coal plant, any vessel in which nested waste matter has formed, and the like. The confined container 106 may have one or more energy impingement devices 108 configured to treat the materials in the confined container 106 as will be discussed in more detail below.

The process system 100 may have any suitable delivery system for delivering the material 102 into and/or out of the confined container 106. As shown, a pipe 110a and 110b is coupled to an inlet 112 and an outlet 114 of the confined container 106. The pipe 110a may deliver untreated materials 102a into the confined container 106. The pipe 110b may deliver the treated materials 102b from the confined container 106 to the location 104. Although the delivery system is shown as pipe 110, it may be any suitable delivery system including, but not limited to, a hopper, piping, a conveyor, flex hose, tubing, any combination thereof, and the like.

The confined container 106 is configured to treat, or effect, the material 102 flowing through the process system 100. The confined container 106 may treat, or effect, the material 102 by any suitable method including, but not limited to, heat, impingement, agitation, chemical reactions, dilution factors, fluid impingement, thermal energy, mixing, organic digestion, propulsion, any combination thereof and the like. Once the materials are treated in the confined container 106, the material 102 has been changed and/or altered for treatment, processing and/or handling. The confined container 106 as shown is a cylindrical container, although it may be any suitable container including but not limited to a spherical container, a rectangular container, a ship-vessel shaped container, a dome container, an underground cavity shaped container, an ovular container and the like. The material 102 in the confined container 106 may be vigorously treated, or mixed. This vigorous treatment may be enhanced by any suitable chemicals, bio-chemicals, microorganisms, additives and the like in order to enhance the treatment process.

The one or more impingement devices 108 may be any suitable device for introducing the treatment into and/or out of the confined container 106. As shown in FIG. 1, the impingement devices 108 are nozzles for injecting fluids into the confined container. The injected fluids 116 may be any suitable fluids including, but not limited to, water, steam, air, gas, additives, chemicals, heated gases, superheated steam, microorganism carrying mixtures, dispersants any combination thereof, and the like. The injected fluids 116 may be entrained with solid matter 118 (such as beads, nano-scale beads, or small engineered pierce-shaped and weighted solids) for creating a “shotgun effect” when the entrained fluid is injected into the confined container 106. Although the impingement devices 108 are shown as nozzles, it should be appreciated that they may be any suitable devices including, but not limited to, orifices, apertures, lanced nozzles and the like.

The treated material 102b exiting via the pipe 110b is affected by one or any combination of factors including, but not limited to, heat, impingement, chemical, dilution agitation and/or propulsion factors. Accordingly, the treated material 102b exists in an altered state (as compared to its condition upon entry as untreated material 102a) and may next be further treated, processed or handled by other means, additional in-line process systems 100 and/or process systems 100 in parallel. In one example, the treated material 102b may next be introduced into another identical process system 100. In another example, the treated material 102b may next be introduced into a commercially available centrifuge. In a third example, the treated material 102b may next be introduced into another identical process system 100 to be followed in line by a commercially available centrifuge. These three examples are not intended to be limiting of the options that are available.

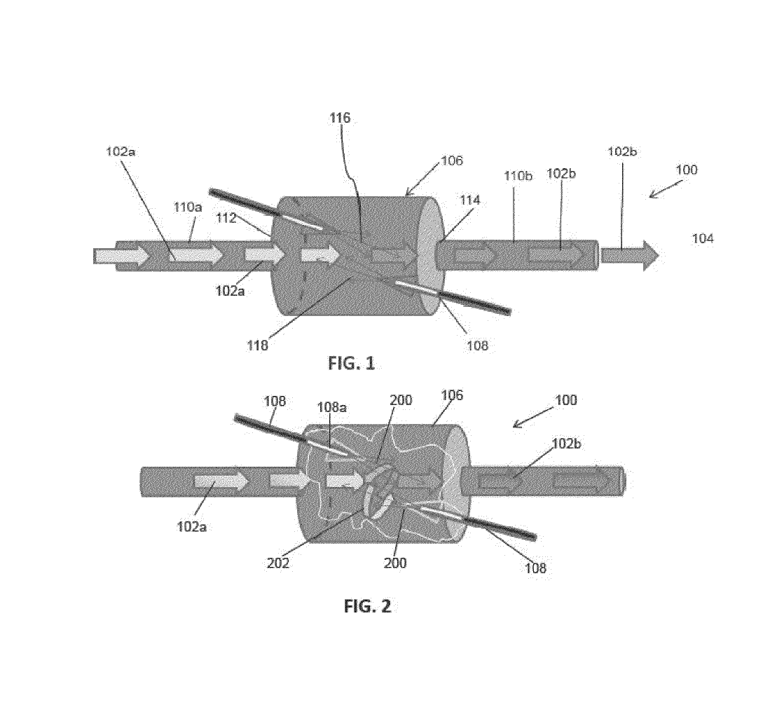

FIG. 2 depicts the process system 100 of FIG. 1 configured to inject high pressure fluid, mixtures or water 200 into the confined container 106 via the impingement devices 108. The high pressure fluid 200 may be heated in order to treat the material 102 flowing through the confined container 106. In an embodiment, the impingement devices 108 may comprise a nozzle creating a turbo nozzle effect configured to swirl and mix the materials 102 as shown by one or more volumes or streams (represented by flow lines) 202 within the confined container 106. The swirling may cause heavier materials to disperse from the main flow of the materials 102 thereby purifying the materials. The nozzles 108 may be indexed to alternate or coordinate by time and/or three dimensional positioning to create eddies or counter-flow volumes or streams (represented by flow lines) 202. The nozzles may be mounted allowing three dimensional rotation, thrusting and/or withdrawal of the nozzle lances 108a for further effect. The confined container 106 may act as a centrifuge to disperse and/or separate the materials flowing through the process system 100.

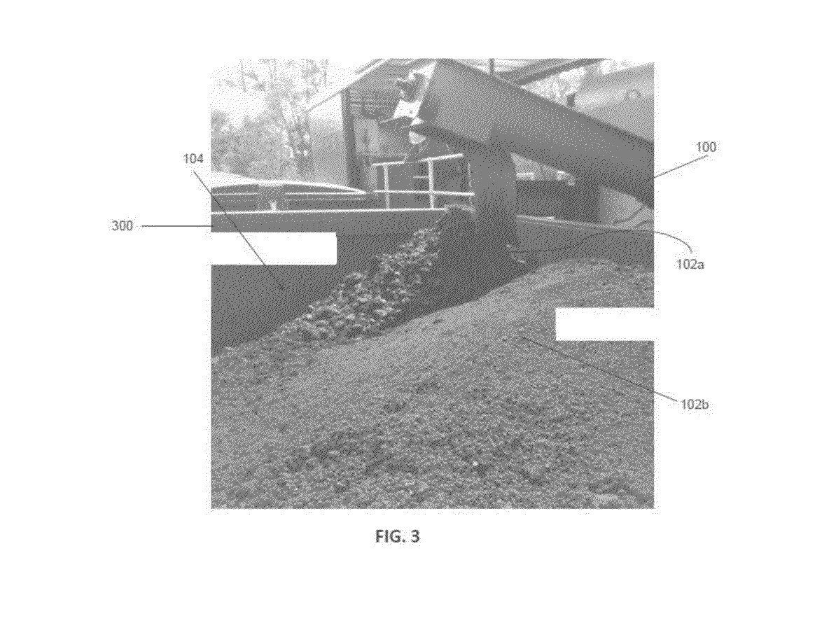

FIG. 3 depicts the location 104 that the materials are finally sent to in an embodiment. In this embodiment, the location is an atmospheric storage container 300. It should be appreciated that the location 104 may be any suitable location including, but not limited to, a storage tank, a pit, another process system and the like. As shown, a portion of the material in the location 104 is the treated material 102b and a portion is untreated material 102a. As shown, the untreated material (or material treated through a centrifuge only) 102a is denser and contains more impurities. The treated material 102b is finer and has fewer impurities. By way of example only, the untreated material 102a may have 14% oil, 22% water and 64% solids, and the treated material may comparatively have 2% oil, 4% water, and 94% solids. The ranges of solids versus oil and water may vary depending on the desired results and process used. Therefore, the confined container 106 may purify the materials 102 flowing through the process system 100 prior to reaching the location 104.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An apparatus as shown, described and/or implied that a confined container with inlet and outlet, that inside the confined container the inlet material undergoes a method where the input material is processed creating a treated material that is changed to the further benefit of the operators desire. This apparatus claims the use of one or more energy impingement devices configured to deliver this energy to the confined treatment container. It is further claimed that the energy delivery system may also be chemical, biological, heat or cold, electrical, vibration in any combination or delivery system not limited to the pipe illustrated in FIG. 1 or 2; and may include any pipe combination, hopper, flex hose, tubing, lance, any combination thereof, and the like used inside this confined container to process. It is further claimed that this container is not limited to the pipe illustrated in FIG. 1 or 2; but may include any containment, container, pipe (ing) or vessel combination, hopper, flex hose, tubing, any combination thereof, and the like. It is further claimed that the inlet or outlet delivery into the confined container is also not limited to the pipe illustrated in FIG. 1 or 2; but may include any delivery apparatus and/ or mechanism, pipe(ing) or other vessel combination, hopper, flex hose, tubing, any combination thereof, and the like.

2. A system as shown, described and/or implied claims the use of vigorous treatment may be enhanced by any chemicals, biological additives or enhancement products that may include food, microorganisms, additives and the like in order to enhance the treatment process.

3. A method as shown described and/or implied claims the confined container uses a delivery system that includes mechanical energy, chemical, thermal changes in order to enhance the treatment process. The method further claims the use of mechanical energy that includes hydro blasting nozzles, shearing tools, mixing devices to enhance the treatment process. It is further claimed that the nozzles may be indexed to alternate or coordinate by time and/or three dimensional positioning to create eddies or counter-flow volumes or streams. The nozzles may be mounted allowing three dimensional rotation, thrusting and/or withdrawal of the nozzle lances for further effect the method of material change.

4. An apparatus and system for treating a nested waste matter, comprising:
a delivery system for delivering a volume of untreated material;
a confined container having an inlet connected to the delivery system;
an energy impingement device introduced transversely into said confined container;
wherein said energy impingement device is configured to deliver a volume of injected fluid and further configured to treat the volume of untreated material in said confined container;
wherein said confined container has an outlet for exiting a volume of treated material.

5. A method for treating a nested waste matter, comprising the steps of:
delivering a volume of untreated material;
confining the untreated material in a container;
independently injecting a volume of treating fluid into the container;
impinging the volume of untreated material with the volume of treating fluid; and
exiting a volume of treated material from the container.

6. The method according to claim 5, wherein said step of independently injecting the volume of treating fluid into the container comprises injecting the volume of treating fluid transversely into the container in at least one impinging volume of flow.
